(19) United States
(12) Patent Application Publication
(10) Pub. No.: US 2025/0272283 A1
(43) Pub. Date: Aug. 28, 2025

(54) REAL TIME RETRIEVAL OF CONTENT ITEMS FOR MULTI-CATEGORY SYNTHESIS AND PERSONALIZED KNOWLEDGE AUGMENTATION

(71) Applicant: Microsoft Technology Licensing, LLC, Redmond, WA (US)

(72) Inventors: Muchen Wu, Mountain View, CA (US); Ashvini Kumar Jindal, San Francisco, CA (US); Nitin Pasumarthy, Sunnyvale, CA (US); Sai Vivek Kanaparthy, San Jose, CA (US)

(21) Appl. No.: 18/590,750

(22) Filed: Feb. 28, 2024

(51) Int. Cl. G06F 16/2452; G06F 16/2457

(52) U.S. Cl. CPC G06F 16/24522; G06F 16/24578

(57) ABSTRACT

Embodiments described herein are capable of providing synthesized and personalized supplemental information to a user. The embodiments describe determining, based on a search result selected by a user, using a LLM, a first set of categories, a first set of keywords, a second set of categories, and a second set of keywords. The embodiments further describe retrieving a set of digital content items. A first digital content item of the set of digital content items is retrieved based on a first category of the first set of categories, and a second digital content item of the set of digital content items is retrieved based on a first category of the second set of categories. The embodiments further describe generating, using a LLM, a summary of one or more digital content items of set of digital content items. The embodiments further describe causing the summary to be displayed on a device.

### TECHNICAL FIELD

Embodiments of the invention relate to the technical fields of digital content synthesis and presentation.

### BACKGROUND

To present digital content items to a user, online systems execute a query, rank the search results returned by the query, and assign the search results to positions based on the ranking. The online system presents the ranked content items in a user interface according to the positions to which the content items are assigned.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for using a knowledge insight system to provide synthesized and personalized supplemental information to a user, in accordance with some embodiments of the present disclosure.

FIG. 2 illustrates a flow diagram for determining categories and keywords from information extracted from a search result, in accordance with some embodiments of the present disclosure.

FIG. 3 illustrates an example flow diagram for summarizing content with respect to a category and/or keyword, in accordance with some embodiments of the present disclosure.

FIG. 4 illustrates an example user interface including a selected search result and synthesized text, in accordance with some embodiments of the present disclosure.

FIG. 5 is a block diagram of a computing system that includes a knowledge insight system, in accordance with some embodiments of the present disclosure.

FIG. 6 is an example of an entity graph, in accordance with some embodiments of the present disclosure.

FIG. 7 is a flow diagram of an example method for providing synthesized and personalized supplemental information to the user, in accordance with some embodiments of the present disclosure.

FIG. 8 is a block diagram of an example computer system including components of an application software system, in accordance with some embodiments of the present disclosure.

### DETAILED DESCRIPTION

Users seeking information via an online system can enter a search query, which the online system may execute to retrieve information and present the retrieved information to the user. Conventional search engines present the retrieved information as a set of search results that are “generic” in the sense that they merely reflect the content of each search result in a standard (e.g., verbatim), non-customized way. Selecting a search result enables the user to receive additional information about the selected search result. For example, a conventional online system presents a set of search results as a list of hyperlinks, where each hyperlink represents one of the search results in the set. The user can select one or more of the hyperlinks to view the corresponding search result (e.g., a web page, document, image, or video referenced by the hyperlink).

The conventional approach to the presentation of search results is inadequate for some information retrieval contexts, such as those in which the user needs to decide whether or not to take a subsequent action based on a search result. In these contexts, conventional approaches lack information that the user needs to evaluate and determine whether to take further action with respect to any of the results. One such context is job search. In job search applications, the user needs to be able to determine quickly whether or not to apply for a job based on the information provided about the job.

For example, a user may select a search result that describes a job opening (e.g., a job opening post). Responsive to the selection of the job opening post, the user receives information about the job opening such as the job duties, the preferred skills for the job, and the company associated with the job. However, the information provided to the user is limited to the contents of the job posting itself. More generally, conventional methods of displaying search results include limited information that is often insufficient for the user to determine whether or not to take a subsequent action such as to submit a job application. In the job search example, additional information that would be helpful to the job seeker could include the latest knowledge about the job position and the latest information about the company associated with the job (such as hiring information, and/or new products released by the company, new articles published by the company). Because these and other types of supplemental information are lacking in conventional job search systems, those systems burden the user with the time consuming tasks of digesting the information included in the job opening post, evaluating the job opening information with respect to the user's set of skills, determining what additional information the user needs to make a decision, and seeking the additional information to fill in the information gaps in the job opening post. In other words, conventional systems shift the responsibility to the user to find and retrieve the most helpful supplemental information, which may be scattered across multiple different online platforms, based on the user's own subjective understanding of the selected search result and the information that is absent from the selected search result. As a result, conventional systems task the user with entering multiple subsequent search queries to search for the absent information and manually mapping the user's skill set to the job requirements provided in the job opening.

A technical problem that arises when the user is required to execute multiple search queries as a result of the conventional approach to search result presentation includes the wasted computing resources associated with extraneous and/or sub-optimal search queries. That is, the user generated search queries may be too broad or too narrow to efficiently retrieve search results that are related to the information gaps associated with the originally selected search result.

Another technical problem is that different users may have different subjective understandings of a selected search result. For example, a job opening may indicate that the desired candidate should have “machine learning experience.” However, the company that uploaded the job opening specifically develops large language models such that “machine learning experience” should be interpreted as “large language model experience.” The searcher user may not understand the company's interpretation of “machine learning experience” without performing subsequent searches to find out more about the company's business or most recent technological developments.

Another technical problem is that different users may have different preferences as to the additional information that they need to make the search result actionable for the user. For example, given a selection of a particular news article from a set of search results, some users may seek to verify the credibility of the article by searching on the author's name while other users may perform the same task of verifying the article's credibility in a different way, such as by searching on keywords mentioned in the article. In other words, the information considered lacking in the originally selected search result can be very subjective, such that different users may have different intents when conducting subsequent searches for additional information (e.g., is the user searching for information that should be verified? Should subsequent searches verify the author of the article, the content of the article, or both?).

Responsive to a selection of a search result, embodiments of the methods and processes described herein interpret the user search intent (e.g., the user's goal or objective when formulating a search to obtain supplemental information about a selected search result) and automatically generate synthesized sets of supplemental information (also referred to herein as knowledge augmentations) based on the user's search intent in relation to the selected search result. The described approaches for interpreting the user search intent enable embodiments of a knowledge insight system described herein to personalize the supplemental information related to the selected search result.

As described herein, responsive to the user's selection of a search result, supplemental information is automatically generated based on user information (e.g., interests, history, current needs, etc.), which is specific to the user selecting the search result. For example, a user selecting a job opening search result who is casually searching for a next job can receive supplemental information including trending news related to the company associated with the job opening search result (e.g., whether the company is growing, new products released by the company, etc.). In contrast, a user selecting a job opening search result who is immediately seeking a next job can receive supplemental information including missing skills required by the job opening and learning videos associated with teaching the user the missing skills. As shown by these examples, embodiments can determine, based on the user information, whether the user's search intent is to find a job immediately or to casually keep up to date on the most recent job openings.

Embodiments of the knowledge insight system described herein interpret the user search intent using the user information and the selected search result and acquire and synthesize supplemental information related to the user search intent without any additional input from the user. The supplemental information is personalized because it is based on user-specific information including the search intent. Embodiments synthesize supplemental information by summarizing information across multiple sources of supplemental information and provide the summarized information to the user as a knowledge augmentation, for instance. For example, embodiments of the knowledge insight system can summarize three news articles related to a selected search result and provide a summary of the contents of the three articles, including references to the three news articles, to the user.

A generative model uses artificial intelligence technology, e.g., neural networks, to machine-generate new digital content based on model inputs and the previously existing data with which the model has been trained. Whereas discriminative models are based on conditional probabilities P (y|x), that is, the probability of an output y given an input x (e.g., is this a photo of a dog?), generative models capture joint probabilities P (x, y), that is, the likelihood of x and y occurring together (e.g., given this photo of a dog and an unknown person, what is the likelihood that the person is the dog's owner, Sam?).

A generative language model is a particular type of generative model that generates new text in response to model input. The model input includes a task description, also referred to as a prompt. A prompt can be in the form of natural language text, such as a question or a statement, and can include non-text forms of content, such as digital imagery and/or digital audio. The prompt can include instructions and/or examples of content used to explain the task that the generative model is to perform. Modifying the instructions, examples, content, and/or structure of the prompt causes modifications to the output of the model. For example, changing the instructions included in the prompt causes changes to the generated content determined by the model.

Prompt engineering is a technique used to optimize the structure and/or content of the prompt input to the generative model. Some prompts can include examples of outputs to be generated by the generative model (e.g., few-shot prompts), while other prompts can include no examples of outputs to be generated by the generative model (e.g., zero-shot prompts). Chain of thought prompting is a prompt engineering technique where the prompt includes a request that the model explain reasoning in the output. For example, the generative model performs the task provided in the prompt using intermediate steps where the generative model explains the reasoning as to why it is performing each step.

A large language model (LLM) is a type of generative language model that is trained using an abundance of data (e.g., publicly available data) such that billions of hyperparameters that define the LLM are used to establish statistical correlations that perform a task. Some pretrained LLMs, such as generative pretrained transformers (GPT) can be trained to perform tasks including natural language processing (NLP) tasks such as text extraction, text translation (e.g., from one language to another), text summarization, and text classification.

The disclosed technologies are described in the context of a search system of an online network-based application software system. For example, news and entertainment apps installed on mobile devices and messaging systems can all function as application software systems that include search systems. An example of a search use case is a user of an online system searching for jobs or job candidates over a professional social network that includes information about companies, job postings, and users of the online system. The above-described terminology is used only for ease of discussion and not to limit the scope of the claims.

The disclosure will be understood more fully from the detailed description given below, which references the accompanying drawings. The detailed description of the drawings is for explanation and understanding, and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains, but can be used with or incorporated into other embodiments, including embodiments shown in other drawings.

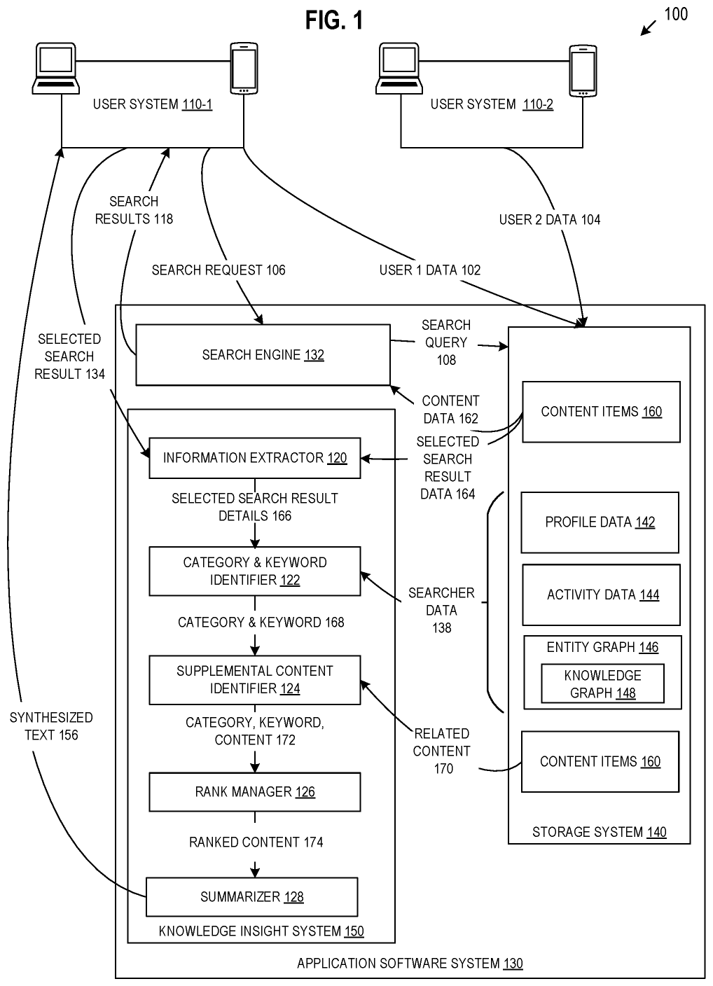

FIG. 1 is a flow diagram of an example method for using a knowledge insight system to provide synthesized and personalized supplemental information to a user, in accordance with some embodiments of the present disclosure.

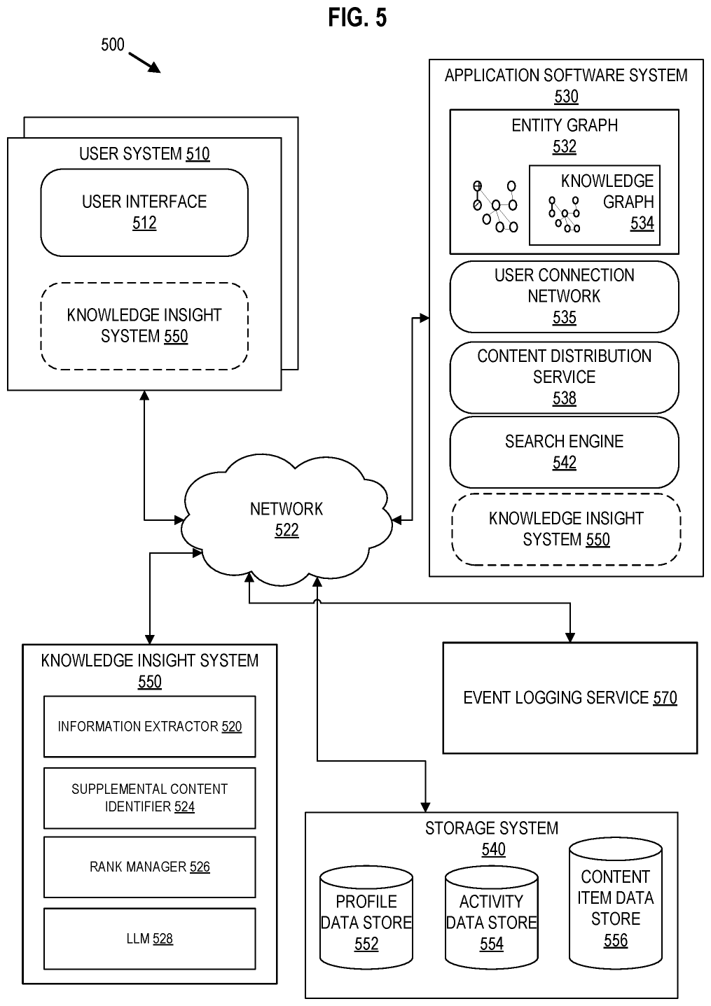

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of the knowledge insight system 150, including, in some embodiments, components shown in FIG. 1 that may not be specifically shown in FIG. 5, or by the knowledge insight system 550 of FIG. 5, including, in some embodiments, components shown in FIG. 5 that may not be specifically shown in FIG. 1, or by components shown in any of the figures that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, in the example computing system 100, an example application software system 130 is shown, which includes a knowledge insight system 150, a storage system 140, and a search engine 132. The knowledge insight system 150 of FIG. 1 includes an information extractor 120, a category and keyword identifier 122, a supplemental content identifier 124, a rank manager 126, and a summarizer 128. The storage system 140 includes content items 160, profile data 142, activity data 144, an entity graph 146 and/or a knowledge graph 148.

In the example of FIG. 1, the components of the application software system 130 are implemented using an application server or server cluster. In other implementations, one or more components of the application software system 130 are implemented on a client device, such as a user system 510, described herein with reference to FIG. 5. For example, some or all of application software system 130 is implemented directly on the user's client device in some implementations, thereby avoiding the need to communicate with servers over a network such as the Internet. In yet other implementations, the components of the knowledge insight system 150 are executed as an application or service, executed remotely or locally.

User systems 110-1 and 110-2 (referred collectively as user systems 110) include at least one computing device, such as a personal computing device, a server, a mobile computing device, or a smart appliance. User systems 110 include at least one software application, enabling the user systems 110 to bidirectionally communicate with the application software system 130. Additionally, the user systems 110 include a user interface that allows a user to enter a search query, select a search result, and receive synthesized and personalized supplemental information about the selected document (referred to herein as synthesized text 156).

As shown, the storage system 140 stores different data associated with user systems 110. In some embodiments, every time the user system 110 interacts with one or more applications of the application software system 130 (e.g., such as search engine 132), the storage system 140 logs and/or stores the user interaction. For example, a user of the user system 110 can interact with applications, services, and/or content presented to the user, thereby generating user 1 data 102 and/or user 2 data 104. Examples of data that can be stored at storage system 140 include content items 160, profile data 142, activity data 144, entity graph 146, and/or knowledge graph 148.

In some embodiments, the storage system 140 stores content items 160 including users registered to the application software system 130, articles posted or uploaded to the application software system 130 such as trending news, and products offered by the application software system 130. The content items 160 can include any digital content that can be displayed to a user via user systems 110 using the application software system 130.

In some embodiments, when a user interacts with an application of the application software system 130 (e.g., via user 1 data 102 and/or user 2 data 104), the user may provide personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. Some or all of such information can be stored as profile data 142. Profile data 142 may also include profile data of various organizations/entities (e.g., companies, schools, etc.).

In some embodiments, when a user interacts with an application of the application software system 130 (e.g., via user 1 data 102 and/or user 2 data 104), the application software system 130 logs the user's interactions. For example, as described with reference to FIG. 5, the application software system 130 may include an event logging service 570. The logged activity is stored as activity data 144. The activity data 144 can include content viewed, links or buttons selected, previous search queries, previous selected results, etc.

In some embodiments, when a user interacts with an application of the application software system 130 (e.g., via user 1 data 102 and/or user 2 data 104), the user engages with one or more other users of the application software system 130 and/or content provided by the application software system 130. As a result, an entity graph 146 is created which represents entities, such as users, organizations (e.g., companies, schools, institutions), and content items (e.g., user profiles, job postings, announcements, articles, comments, and shares), as nodes of a graph. Entity graph 146 represents relationships, also referred to as mappings or links, between or among entities as edges, or combinations of edges, between the nodes of the graph. In some implementations, mappings between or among different pieces of data are represented by one or more entity graphs (e.g., relationships between different users, between users and content items, or relationships between job postings, skills, and job titles). In some implementations, the edges, mappings, or links of the entity graph 146 indicate online interactions or activities relating to the entities connected by the edges, mappings, or links. For example, if a user clicks on a news article, an edge may be created connecting the news article with the user entity in the entity graph, where the edge may be tagged with a label such as “viewed.”

Portions of entity graph 146 can be automatically regenerated or updated from time to time based on changes and updates to the stored data, e.g., in response to updates to entity data and/or activity data from a user via user data 1 102 and/or user data 2 104. Also, entity graph 146 can refer to an entire system-wide entity graph or to only a portion of a system-wide graph, such as a sub-graph. For instance, entity graph 146 can refer to a sub-graph of a system-wide graph, where the sub-graph pertains to a particular entity or entity type.

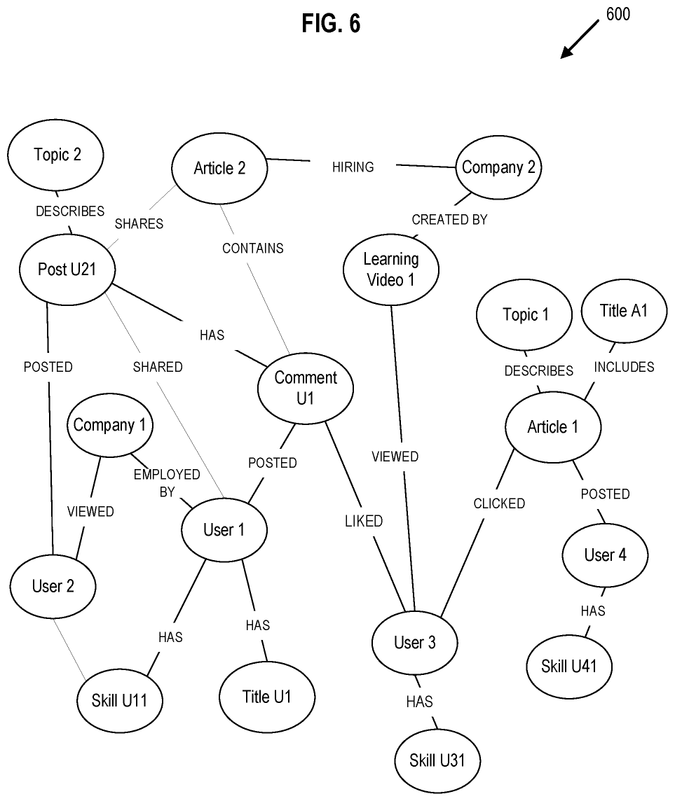

Not all implementations have a knowledge graph, but in some implementations, knowledge graph 148 is a subset of entity graph 146 or a superset of entity graph 146 that also contains nodes and edges arranged in a similar manner as entity graph 146, and provides similar functionality as entity graph 146. For example, in some implementations, knowledge graph 148 includes multiple different entity graphs 146 that are joined by cross-application or cross-domain edges or links. For instance, knowledge graph 148 can join entity graphs 146 that have been created across multiple different databases or across multiple different software products. As an example, knowledge graph 148 can include links between content items that are stored and managed by a first application software system and related content items that are stored and managed by a second application software system different from the first application software system. Additional or alternative examples of entity graphs and knowledge graphs are shown in FIG. 6 described below.

Application software system 130 is any type of application software system that provides or enables at least one form of digital content distribution of content items 160 to user systems 110. Examples of application software system 130 include but are not limited to connections network software, such as social media platforms, and systems that are or are not based on connections network software, such as general-purpose search engines, job search software, recruiter search software, sales assistance software, content distribution software, learning and education software, or any combination of any of the foregoing.

As shown in the example of FIG. 1, in operation, the search engine 132 receives a search request 106 from a user system such as user system 110-1. The search engine communicates a search query 108 to the storage system 140 to retrieve content data 162 from stored content items 160 relevant to the search query. In an example, the search engine 132 receives a search request 106 from a user system 110-1 (e.g., a searcher) for a list of job openings in the Artificial Intelligence space. The search engine 132 includes, for example, a software system designed to search for and retrieve information by executing queries on content items 160 stored in the storage system 140. The search query 108 is designed to find information that matches specified criteria, such as keywords and phrases of the search request 106 (e.g., job openings in the Artificial Intelligence space). As a result of the search query 108, the search engine 132 receives content data 162 from the storage system 140. In some embodiments, the search engine 132 communicates a search query 108 to one or more external systems or databases to retrieve content data 162. For example, the search engine 132 crawls digital content (e.g., websites) for content data 162 associated with the search query 108. Alternatively or additionally, in some embodiments, the search engine 132 retrieves data from other sources, such as profile data 142, activity data 144, entity graph 146 and/or knowledge graph 148, and/or uses any of such other sources to identify and retrieve content data 162.

The search results 118 (including one or more content data 162) are provided to user system 110-1 via a landing page such that a user can select a search result of the set of search results 118 to obtain more information about the selected search result. In some embodiments, before the set of search results 118 are provided to the user system 110-1, additional processing is performed. For example, one or more filtering algorithms or ranking algorithms can be applied to the set of content data 162 displayed to the user system 110-1 via the landing page. In some embodiments, credential authorization and/or verification is performed to ensure that the user system 110-1 has the proper credentials to view the set of search results 118.

Responsive to viewing the search results 118 on the landing page, the user system 110-1 selects a search result of the set of search results 118. The selection of the search result can be a verbal command, a hand gesture, an eye gesture, a click, and the like. The selected search result 134 represents the user intent of obtaining additional information related to the selected search result from the set of search results 118. The selected search result 134 is provided to the knowledge insight system 150 such that synthesized text 156 related to the selected search result 134 is provided to the user, as described herein. The synthesized text 156 includes personalized and synthesized information related to the selected search result 134 and the user selecting the search result (e.g., user 1 operating user system 110-1).

In operation, the information extractor 120 obtains an indication of the selected search result 134 using metadata of the selected search result 134. For example, the information extractor 120 can receive an identification number (e.g., a job ID) that is used to map the selected search result 134 to a content item 160 (a particular job post). Subsequently, the information extractor 120 fetches the job details (e.g., selected search result data 164) based on the identification number. Other identifiers associated with the content items 160 can be received by the information extractor 120 such as a URL or other local or remote storage location and used to fetch selected search result data 164. The selected search result data 164 represents a particular digital content item of the content items 160 stored in the storage system 140. For example, the selected search result data 164 can be a news article, a job posting, a video, or an entity profile (e.g., a user profile or a company profile). The selected search result data 164 can include text, images and/or figures.

The information extractor 120 obtains information from the selected search result data 164. For example, the information extractor 120 can perform one or more natural language algorithms to extract all of the text data of the selected search result data 164. Additionally or alternatively, the information extractor 120 can perform one or more object recognition and/or object detection algorithms to extract all of the image data of the selected search result data 164. The information extractor 120 passes the extracted information from the selected search result data 164 as selected search result details 166 to the category and keyword identifier 122. For example, all of the text extracted from the selected search result data 164 is passed to the category and keyword identifier 122 as selected search result details 166.

The category and keyword identifier 122 receives the selected search result details 166 and searcher data 138 to identify one or more categories and/or one or more keywords associated with the selected search result details 166. A category is a word or phrase that describe a group of similar content and includes various subsections For example, a category of a job post can be each of the sections of the job post such as “skill requirement” or “duties performed.” A keyword or key-phrase is the subsection of the category. For example, a keyword associated with a “skill requirement” category and based on a selected job post for an entity that does machine learning research can be “machine learning.”

The category and keyword identifier 122 receive search data 138 using metadata associated with the user selecting the search result 134 and/or the user entering search request 106. For example, a user may be logged into a user account with corresponding profile data 142 and/or activity data 144 when the user searches request 106. The user account is mapped to the user via a user identification (e.g., username, IP address, or other metadata). When the user enters search request 106 and/or selects search result 134, such metadata associated with the user profile is obtained to map the user account to the corresponding profile data 142 and/or activity data 144. Accordingly, the profile data 142 and/or activity data 144 become searcher data 138 used by the category and keyword identifier 122 to determine personalized categories and/or keywords with respect to the user account. In some embodiments, the activity data 144 and/or user account is included as an edge or node in entity graph 146 and/or knowledge graph 148. Accordingly, the entity associated with the user account can be extracted from the entity graph 146 and/or knowledge graph 148 and included as search data 138.

The category and keyword identifier 122 can be any LLM such as a pretrained machine learning model trained to perform one or more natural language tasks. For example, the category and keyword identifier 122 can be a text-based encoder-decoder model that accepts a string as an input (e.g., the selected search result details 166 including the extracted information from the selected search result data 164 and the searcher data 138 including the profile data 142, the activity data 144, the entity graph 146, and/or the knowledge graph 148) and outputs a string (e.g., one or more categories and keywords related to the selected search result details 166).

A layer may refer to a sub-structure of the category and keyword identifier 122 that includes a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error during a training phase. The adjustment of the weights during training facilitates the category and keyword identifier 122 ability to identify categories and keywords from text.

The category and keyword identifier 122 can include one or more self-attention layers that are used to attend (e.g., assign weight values) to portions of the received text as the received text travels between layers of the category and keyword identifier 122. Alternatively, or in addition, the category and keyword identifier 122 includes one or more feed-forward layers and residual connections that allow the category and keyword identifier 122 to machine-learn complex data patterns including relationships between different portions of the model input in multiple different contexts.

The output of the category and keyword identifier 122 is one or more categories and one or more associated keywords 168. For ease of description, the present disclosure describes the category and keyword identifier 122 outputting pairs of categories and keywords, but it should be appreciated that the category and keyword identifier 122 can receive selected search result details 166 such as text of a single document (e.g., selected search result data 164) and searcher data 138 and determine X number of categories, where each category of the X number of categories is associated with Y number of keywords. That is, a category can be paired with multiple keywords. In some embodiments, the category and keyword identifier 122 is a GPT machine learning model.

The pairs of categories and keywords 168 are passed to the supplemental content identifier 124. The supplemental content identifier 124 is configured to obtain content material related to the identified categories and keywords 168. The supplemental content identifier 124 can query any one or more databases for content items such as content items 160 stored in the storage system 140. For example, the supplemental content identifier 124 can use an Application Program Interface (API) call to query one or more databases. An API refers to an interface or communication protocol in a predefined format between a client and a server, for instance. In response to receiving an API call, an action is initiated and generally a response is communicated. For example, the supplemental content identifier 124 uses an API call to communicate a request for content that is semantically similar to the categories and keywords 168 and/or that matches the categories and keywords 168 to one or more content items 160 stored in databases (such as the storage system 140). Responsive to receiving the API call with request for content, the storage system 140 identifies related content 170 and communicates an API response with the related content 170. In some embodiments, related content 170 is retrieved from multiple databases. For example, a first related content item 170 is received from a first database and a second related content item 170 is retrieved from a second database.

The related content 170 is a set of digital content items that is associated with one or more categories and one or more keywords of the set of categories and keywords 168. For example, a first digital content item of the related content 170 is associated with a first category of the set of categories and keywords, and a second digital content item of the related content 170 is associated with a second category of the set of categories and keywords. The related content 170 can include any digital content such as recordings, learning courses, news posts, articles, entity profiles (e.g., user profiles, organization profiles), and/or images. In some embodiments, the related content 170 is the digital content itself. In some embodiments, the related content 170 is metadata associated with a particular content item of the set of content items 160. For example, the related content 170 can include an identification number corresponding to a particular content item of the set of content items 160. Other identifiers can be metadata associated with a particular content item as a URL or other local or remote storage location. In some embodiments, the related content 170 includes both the digital content (e.g., an article) and metadata such as an identifier of the digital content (e.g., a URL address of the article).

In some embodiments, the supplemental content identifier 124 can use embedding based retrieval (EBR) to identify related content 170. For example, the supplemental content identifier 124 can encode the categories and keywords 168 to obtain embeddings of categories and/or embeddings of keywords. An embedding is a latent space representation of the category and/or keyword that encodes the meaning of the category and/or keyword in an embedding space. Embeddings associated with similar meanings are positioned closer together in embedding space.

In some embodiments, the content items 160 stored in the storage system 140 are encoded into embeddings such that the storage system 140 stores embeddings of the content items. The embeddings of the categories and keywords 168 are compared to the embeddings of the content items 160 stored in the storage system 140. In some embodiments, cosine similarity is applied to the pairs of compared embeddings to quantify the similarity between the embeddings. In operation, the value of the cosine of the angle between the compared embeddings in embedding space indicates a similarity of embeddings. For example, higher, positive values (closer to 1) indicate greater degrees of similarity and lower, negative values (closer to 0) indicate greater degrees of dissimilarity. In some embodiments, the k most similar embedding pairs (e.g., the embeddings of the categories and/or keywords of categories and keywords 168 compared to embeddings of the content items 160) are selected as k related content 170. The output of the supplemental content identifier 124 includes a list of related information. For example, categories and corresponding keywords are included in the category, keyword, and content 172 determined by the supplemental content identifier 124. Additionally, related content 170 is included in the category, keyword, and content 172. In some embodiments, category, keyword, and content 172 is in the following structured format: <category 1, keyword 1, content 1, content 2>.

The rank manager 126 ranks the content (e.g., related content 170 included in the category, keyword, and content 172) according to a category and/or a keyword (e.g., category and keywords 168 included in the category, keyword, and content 172). For example, the rank manager 126 ranks the content based on a relevance of each content item of the set of related content 170 to a category of the set of categories in categories and keywords 168. Additionally or alternatively, the rank manager 126 ranks the content based on a relevance of each content item of the set of related content 170 to a keyword associated with a category. Accordingly, a content item may be ranked in a high position (indicating the content item is relevant) to a first category and the same content item may be ranked in a low position (indicating the content item is not relevant) to a second category. In this manner, content items are grouped based on relevance for a particular category of the set of categories or keywords of the set of keywords.

In some embodiments, the rank manager 126 is a machine learning model that uses a learning-to-rank algorithm to learn a function that assigns a score to one or more content items. Examples of learning-to-rank techniques include pointwise methods, pairwise methods, and listwise methods.

Listwise learning-to-rank techniques rank items in a list based on a permutation of items and not based on the score that each item received. That is, with listwise learning-to-rank, the list of content items is treated as a single unit. For example, given an input of a list of items A, B, C and a category or keyword of the category and keywords 168 included in the category, keyword, and content 172, an output of a model executing listwise ranking is a ranking of the list of items ABC, e.g., a ranking score that reflects the relevance of the entire list A, B, C to the category or keyword. In contrast, pointwise learning-to-rank ranks items based on a score associated with each entry to be ranked. That is, with pointwise learning-to-rank, each item to be ranked is scored independently. For example, given the input of A, B, C and a category or keyword, an output of a model executing pointwise ranking is a score of A (85% relevant to the category or keyword), B (50% relevant to the category or keyword) and C (20% relevant to the category or keyword). In pairwise learning-to-rank, pairs of neighboring entries are ranked according to a score associated with pairs of entries. For example, given the input of A, B, C and a category or keyword, an output of a model executing pairwise ranking is score of pairs of inputs (e.g., A is 85% more relevant to the category or keyword than B, B is 30% more relevant to the category or keyword than C, etc.). Thus, whereas pointwise learning-to-rank computes a score for each individual item to be ranked (where the items are ranked based on the individual scores) and pairwise learning-to-rank computes a score for each pair of items to be ranked (where the pairs are ranked based on the scores computed for the pairs), listwise learning-to-rank computes a score for each list of items to be ranked (where the lists are ranked based on the scores computed for the lists).

In some embodiments, the rank manager 126 is an LLM that is instructed to rank the related content 170 included in the category, keyword, and content 172 to a category and/or a keyword of the category, keyword, and content 172 using a prompt.

The rank manager 126 can select the top k number of content items in each group for synthesis of content related to that group. For example, the top three content items that are relevant to the first category are synthesized, and the top three content items that are relevant to the first keyword of the first category are synthesized. Additionally or alternatively, the top three content items that are relevant to the first category are synthesized, and the top three content items that are relevant to the second category are synthesized. The rank manager 126 passes top-ranked content 174 and the associated category or keyword to the summarizer 128. In some embodiments, the rank manager 126 passes the group of ranked content items to the summarizer 128 and the summarizer 128 selects the top k ranked digital content items of the group of ranked content items.

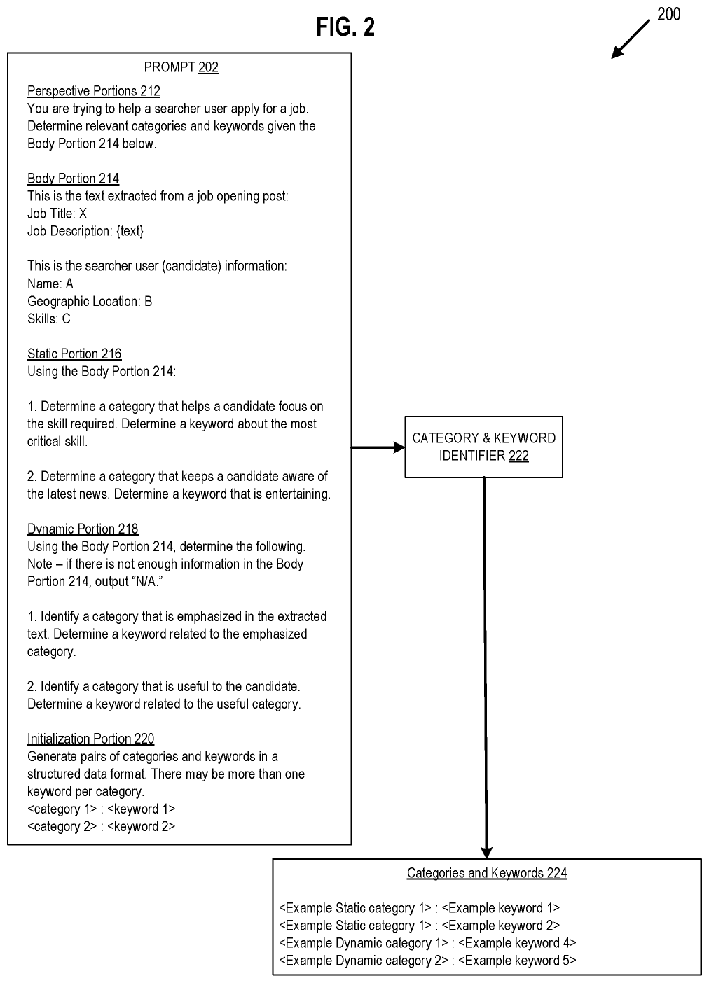

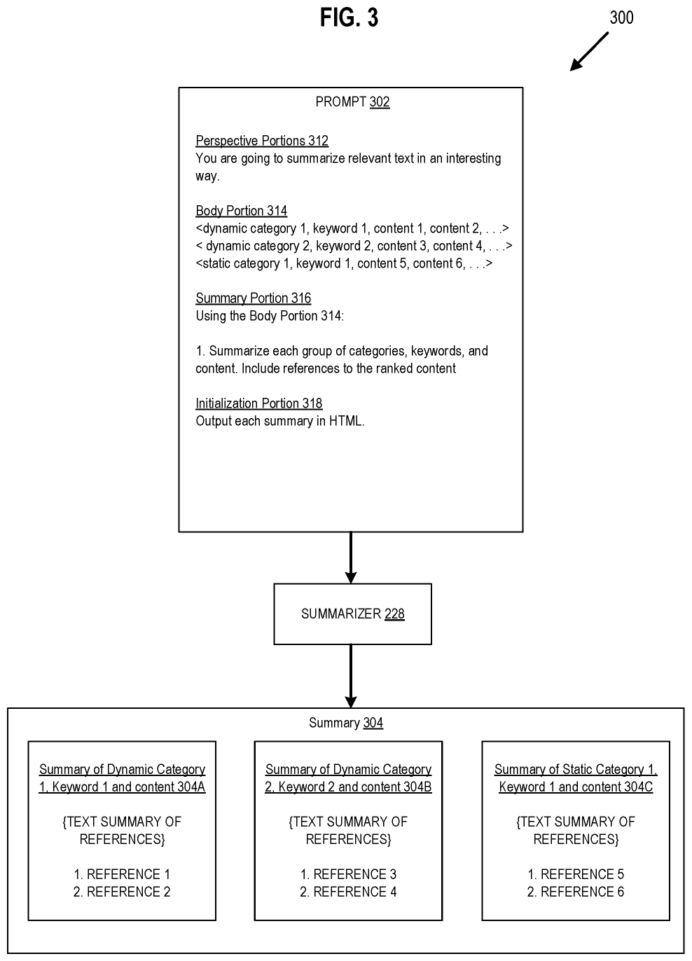

The summarizer 128 synthesizes the top-ranked content 174. In some embodiments, the summarizer 128 is the same LLM as the category and keyword identifier 122. The LLM (e.g., category and keyword identifier 122) receives a first prompt that instructs the LLM to determine categories and keywords 168 associated with the searcher data 138 and the selected search result details 166. An example first prompt is described in FIG. 2. The LLM (e.g., summarizer 128) receives a second prompt that instructs the LLM to summarize ranked content 174 according to a category or keyword determined by the category and keyword identifier 122. An example second prompt is described in FIG. 3. In other embodiments, the summarizer 128 is a different machine learning model from the category and keyword identifier 122 machine learning model.

The summarizer 128 receives a group of content and a corresponding keyword and/or category and generates a synthesized text 156 of the group of content related to the keyword and/or category. The synthesized text 156 is a summary of the content items of the group of content items and can include a citation (or other reference identifier) for each content item of the group of content items included in the summary (e.g., synthesized text 156).

The synthesized text 156 is provided for display to the user using user system 110-1. For example, in response to the user selecting a search result 134, the user is directed to a page to obtain the content associated with the selected search result. While the user is reviewing the content associated with the selected search result, the knowledge insight system 150 updates the page associated with the selected search result with the synthesized text. For example, the knowledge insight system 150 can create a pop-up window for each synthesized text 156, and/or append the synthesized text 156 to a portion of the page associated with the selected search result. In a non-limiting example, the user selects search result 134 to obtain information about a particular search result from a set of search results (e.g., a landing page). Responsive to the selection of the search result, the user reviews the content associated with the selected search result on a webpage. The synthesized text 156 is displayed to the user via the webpage by, for instance, augmenting the webpage with the synthesized text 156. In some embodiments, as synthesized text 156 is generated by the summarizer 128, the synthesized text 156 is added to the bottom of the webpage, for instance. In other embodiments, the synthesized text 156 is added to the bottom of the webpage after the summarizer 128 has generated each summary of grouped content items. For example, given three groups of content items (and corresponding keywords and/or categories), three synthesized texts 156 are added to the bottom of the webpage at or around the same time. Providing the synthesized text 156 to the user in this manner (e.g., by augmenting a webpage that a user is viewing, for example) allows the synthesized text 156 to continue the user's thought after the user has completed consuming the original content on the webpage. For example, in response to reading information associated with a particular job position, questions that the user may have had with respect to the particular job position are addressed by the synthesized text 156 that is added to the webpage, where the synthesized text 156 is personalized to the user and the particular job position.

The examples shown in FIG. 1 and the accompanying description above are provided for illustration purposes. This disclosure is not limited to the described examples. Additional or alternative details and implementations are described herein.

FIG. 2 illustrates a flow diagram for determining categories and keywords from information extracted from a search result, in accordance with some embodiments of the present disclosure.

As described herein, a prompt instructs a LLM of one or more tasks to be performed by the LLM. The category and keyword identifier 222 is an LLM configured to determine categories from extracted information, and for each of the X categories, the category and keyword identifier 222 can determine Y related keywords.

Example 200 illustrates a portion of prompt 202 passed to category and keyword identifier 222 to determine one or more keywords and one or more categories associated with information. While example 200 illustrates five portions of prompt 202 (e.g., perspective portion 212, body portion 214, static portion 216, dynamic portion 218, and initialization portion 220), other portions of a prompt can be included in prompt 202 and passed to category and keyword identifier 222.

The perspective portion 212 is a portion that defines role play of the language model. For example, the perspective portion 212 states that the language model is trying to help someone apply for a job and that the language model needs to determine relevant categories and keywords given the information in the prompt. The role play instruction provided to the language model in the perspective portion guides the language model on what categories and keywords the language model should determine from the information in the body portion 214. While a career-oriented instruction is provided in perspective portion 212, other role-playing instructions can be provided to the language model. For example, the category and keyword identifier 222 can assume the role of an entity (such as a person or company) performing an action via the perspective portion 212.

The body portion 214 includes the extracted information (e.g., content of the search result selected by the user such as selected search result details 166 extracted from selected search result data 164, as described in FIG. 1) that is used to determine categories and keywords. The body portion 214 also includes searcher user (e.g., candidate) information (such as profile data 142, activity data 144, entity graph 146 and/or knowledge graph 148 as described in FIG. 1). In some embodiments (not shown), the body portion 214 also includes the search request used to generate the selected search result (such as the search request 106 and selected search result 134 as described in FIG. 1).

The prompt 202 also includes static portion 216. The static portion 216 provides instructions for the category and keyword identifier 222 to identify a predetermined set of categories and corresponding keywords for any type of job post (or more generally, the content of the search result selected by the user). As shown, two example instructions are provided in static portion 216. Accordingly, in example 200, for any received job post, the category and keyword identifier 222 will determine two predetermined categories and one or more keywords associated with the two predetermined categories provided in static portion 216. The two example instructions are generic instructions used to obtain generic information about the job position. For example, the first instruction will guide the category and keyword identifier 222 to determine a “required skills” category associated with the job post, and also determine a most critical skill keyword of the required skills (e.g., a first predetermined keyword associated with a first predetermined category). The second instruction will guide the category and key identifier 222 to determine a “latest news” category associated with the job post, and also determine an “entertaining” keyword associated with the latest news (e.g., a second predetermined keyword associated with a second predetermined category).

The prompt 202 also includes dynamic portion 218. The dynamic portion 218 can provide instructions for the category and keyword identifier 222 to determine categories and keywords unique to the job post (or more generally, the content of the search result selected by the user). As shown, the first instruction of the dynamic portion 218 guides the category and keyword identifier 222 to determine a category (e.g., a word or phrase that semantically captures the main theme of a group of similar content included in the job position) that is emphasized in the job position. For example, the entity posting the job position may heavily describe work culture. Accordingly, the category and keyword identifier 222 determines “work culture” as a category. Similarly, the entity posting the job position may indicate flexible hours and flexible remote options such that the category and keyword identifier 222 determines “work life balance” as a keyword related to the “work culture” category.

The dynamic portion 218 can also provide instructions for the category and keyword identifier 222 to determine categories and keywords unique to the searcher user (e.g., a candidate searching for a job). As shown in prompt 200, the second instruction of the dynamic portion 218 guides the category and keyword identifier 222 to determine a category that is useful for the searcher user based on the user information associated with the user that selected the search result (e.g., searcher data 138 described in FIG. 1). For example, the category and keyword identifier 222 can compare the searcher user's past employment history and/or skills to preferred qualifications identified in the job positing to determine keywords related to the user's skill deficiencies. As a result, the category and keyword identifier 222 determines the dynamic category to be “required skills.”

The categories and keywords identified using the dynamic portion 218 depend on the information available in the body portion 214. For example, there may be limited searcher information (e.g., searcher data 138 such as profile data 142, activity data 144, entity graph 146, and/or knowledge graph 148 described in FIG. 1) such that the category and keyword identifier 222 cannot determine some personalized (or dynamic) information. For instance, if a user does not upload their resume (e.g., a type of data stored in profile data 142), the category and keyword identifier 222 may not have sufficient information to compare the user's skills to the skills identified in the job posting. Accordingly, if there is insufficient information to determine a category and/or keyword using the searcher information, then the dynamic portion 218 of the prompt 202 instructs the category and keyword identifier 222 to output “N/A” for instance, reducing any hallucinations that may have been performed by the category and keyword identifier 222.

In some embodiments, the category and keyword identifier 222 merges keywords associated with similar categories. In a non-limiting example, the static portion 216 of the prompt 202 may result in the category and keyword identifier 222 determining the category “required skills.” Similarly, the dynamic portion 218 of the prompt 202 may result in the category and keyword identifier 222 determining the same category, “required skills.” Accordingly, the category and keyword identifier 222 can merge keywords associated with each category (such as a skill deficiency keyword resulting from the dynamic portion 218 of the prompt 202 and a critical skill keyword resulting from the static portion 216 of the prompt 202) into the single category “required skills.”

The prompt 202 also includes an initialization portion 220, which instructs the language model to perform the task described in the prompt 202. As shown, the category and keyword identifier 222 is instructed to generate pairs of categories and keywords in a structured data format such as JavaScript Object Notation (JSON).

The category and keyword identifier 222 uses the prompt 202 to determine one or more categories and one or more keywords 224. In some instances, the categories and keywords 224 determined by the category and keyword identifier 222 are included in the received text (e.g., the body portion 214 that includes the job opening post). That is, the category and keyword identifier 222 can extract categories and keywords from the text. In some instances, the categories and keywords determined by the category and keyword identifier 222 are generated. That is, the category and keyword identifier 222 can generate words and/or phrases that capture categories of information and corresponding keywords related to the categories, where such generated words and/or phrases are not included in the received text.

As shown, the categories and keywords 224 are output in a structured data format such that categories are associated with their related keywords. The categories and corresponding keywords are stored as pairs. As shown, one category (e.g., static category 1) can be paired with multiple keywords (e.g., keyword 1 and keyword 2).

In some embodiments, the categories and keywords 224 can be ranked. For example, the prompt 202 can include an instruction (not shown) for the category and keyword identifier 222 to rank the categories and keywords 224. In other embodiments, the rank manager 126 described in FIG. 1 performs the ranking using pointwise methods, pairwise methods, and/or listwise methods as described herein. Additionally or alternatively, the rank manager 126 described in FIG. 1 performs the ranking using any other suitable ranking method.

In a non-limiting example, dynamic categories (and corresponding dynamic keywords) can be ranked higher than static categories (and corresponding static keywords) because dynamic categories are personalized with respect to the user and/or the selected search result (e.g., the job post). As described above, in some instances, there may not be enough searcher information for the category and keyword identifier 222 to determine dynamic categories and dynamic keywords associated with the dynamic portion 218 of the prompt. Accordingly, the static categories (and corresponding static keywords) are ranked higher than the dynamic categories (and corresponding dynamic keywords). In some embodiments, the top k number of categories and keywords of the ranked categories and keywords 224 are selected for subsequent processing (e.g., passed to the supplemental content identifier 124 as described in FIG. 1).

FIG. 3 illustrates an example flow diagram for summarizing content with respect to a category and/or keyword, in accordance with some embodiments of the present disclosure.

In some embodiments, portions of prompt 302 are similar to portions of prompt 202 described in example 200 of FIG. 2. For example, the perspective portion 312 is a portion that defines the role of the language model.

The prompt 302 includes a body portion 314 that includes the category, keyword, and content 172 as described in FIG. 1. In some embodiments, the summarizer 328 ranks categories, keyword, and content. In some embodiments, the category, keyword, and content is ranked content 174 ranked by the rank manager 126, as described in FIG. 1. For example, the categories included in the body portion are ranked. For instance, dynamic categories, which are personalized with respect to the selected search result and/or personalized with respect to a particular searcher user and determined using the dynamic portion 218 of prompt 202 described in FIG. 2, are ranked higher than static categories, which are generic with respect to any search result and determined using the static portion 216 of prompt 202 described in FIG. 2. As described herein, each category can be associated with one or more keywords. Accordingly, each keyword within a category can be ranked. Additionally, each content item associated with each category and/or keyword can be ranked. Accordingly, the body portion 314 includes structured data including categories, keywords, and content.

The prompt 302 also includes a summary portion 316 that instructs the summarizer 328 to generate a summary for each group of content items. For example, a first summary is generated for a first group of content items that are associated with a first dynamic category and one or more keywords, a second summary is generated for a second group of content items that are associated with a second dynamic category and one or more keywords, and a third summary is generated for a third group of content items that are associated with a first static category and one or more keywords. Accordingly, the summarizer 328 generates three summaries for three groups of content items. To mitigate the summarizer 228 hallucinating information, the summarizer 228 is instructed to include references to the content items used in each summary.

In some embodiments, the summary portion 316 includes one or more retrieval augmented generation (RAG) sentences associated with a content item in a group of content items. As described herein, content items are retrieved (e.g., by the supplemental content identifier 124 described in FIG. 1) because they are associated with at least one category or keyword. In some embodiments, EBR is used to extract one or more sentences from each content item that is related to the at least one category or keyword. For example, a news article of a new product release can be associated with the “trending news” category. The summarizer 328 (or other module) can retrieve one or more sentences from the news article that are most similar to the “trending news” category based on the similarity of the sentence to the “trending news” category using EBR. Additionally or alternatively, the summarizer 328 (or other module) can retrieve one or more sentences from the news article that are most similar to the “Product A” keyword associated with the “trending news” category using EBR. Such sentences are used as RAG sentences by the summarizer 228 to mitigate hallucinating content. That is, instead of generating new content for summary 304, the summarizer inserts the RAG sentences into summary 304 such that the sentences remain faithful to the content from which they were extracted. Responsive to inserting a RAG sentence into summary 304, the summarizer 328 cites the reference. In some embodiments, the summarizer 328 cites the reference using a reference identifier after the RAG sentence, using a foot note, or somewhere else associated with the summarized content (e.g., at the end of the summary 304). The reference identifier can be a URL, a proper citation, or any other mechanism used to identify the source of the reference.

The prompt 302 also includes an initialization portion 318, which instructs the summarizer 328 to perform the task described in the prompt 302. As shown, the summarizer 328 is instructed to generate a summary for each group of content in HTML format. As shown, a first summary 304A of summary 304 is a summary of content 1 and content 2 associated with the dynamic category 1 and keyword 1; a second summary 304B of summary 304 is a summary of content 3 and 4 associated with dynamic category 2 and keyword 2; and a third summary 304C of summary 304 is a third summary of content 5 and content 6 associated with static category 1 and keyword 1.

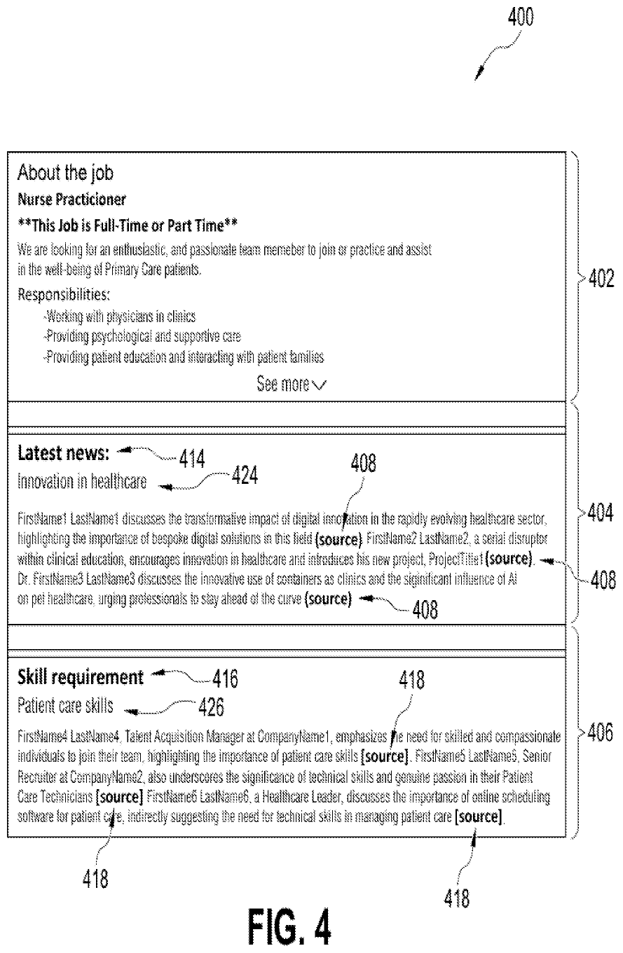

FIG. 4 illustrates an example user interface including a selected search result and synthesized text, in accordance with some embodiments of the present disclosure.

Example 400 displays one implementation of a user interface presented by an application software system (such as application software system 130 described in FIG. 1), to a user who has selected a search result from a landing page displaying a set of search results, for instance. In some implementations, the user interface is implemented as a web page that is stored, e.g., at a server or in a cache of a user device.

As described above, the knowledge insight system (e.g., knowledge insight system 150 described in FIG. 1) generates one or more synthesized texts responsive to the user selection of a search result from a set of search results. Block 402 of example 400 represents the search result selected by a user. Block 402 can be loaded into a display of a user device via the user device sending a page load request to a server. Over a duration of time (e.g., the time spent by the user reviewing the information contained in block 402), one or more synthesized texts are loaded onto the page displayed to the user. That is, the page displayed to the user is updated with synthesized text in real time or near real time (e.g., as the user is reviewing the information contained in block 402).

As described herein, the knowledge insight system (e.g., knowledge insight system 150 described in FIG. 1) determines categories and keywords associated with the information contained in block 402. A first category 414 is illustrated in block 404 and a second category 416 is illustrated in block 406. Similarly, a first keyword 424 is illustrated in block 404 and a second keyword 426 is illustrated at block 406. As shown, each keyword is related to a category. For example, the first keyword 424 “Innovation in Healthcare” is a subset of information related to the first category 414 “Latest News” in block 404. Similarly, the second keyword 426 “Patient Care Skills” is a subset of information related to the second category 416 “Skill Requirement” in block 406.

Each block represents synthesized text from one or more supplemental documents (e.g., the related content 170 described in FIG. 1). Further, each block is relevant to one or more categories and keywords. For example, block 404 includes content relevant to “Latest News” (first category 414) and “Innovation in Healthcare” (first keyword 424). Similarly, block 406 includes content relevant to “Skill Requirement” (second category 416) and “Patient Care Skills” (second keyword 426).

Each block also includes a reference identifier, identifying the reference used to synthesize a particular content item of the content included in the respective block. For example, block 404 includes reference identifiers 408 to three references used to synthesize block 404. Similarly, block 406 includes reference identifier 418 to three references used to synthesize block 406. The reference identifiers are located at the end of sentences to attribute the facts of that sentence to the reference. Reference identifiers can be displayed in other ways, such as foot notes.

The page that is used to display block 402 is updated with block 404 and 406 in real time. The purpose of the synthesized information included in each block (e.g., block 404 and 406) represents the chain of thoughts that the knowledge insight system (e.g., knowledge insight system 150 described in FIG. 1) interpreted for the searcher user. For example, responsive to reading the content of block 402, the search user may have questions. The user experience is improved by updating the page currently viewed by the user to include one or more blocks (e.g., block 404 and/or block 406) because such blocks, being personalized with respect to the user and the selected search result, are answers to predictions of the questions the user may have had. Accordingly, the blocks continue the user's chain of thought.

In some embodiments, the page that is used to display block 402 is updated with a first block such as block 404 and after a next duration of time, the page that is used to display block 402 and 404 is updated with a second block such as block 406. In other embodiments, the page that is used to display block 402 is updated with blocks 404 and 406 concurrently (or near concurrently).

FIG. 5 is a block diagram of a computing system that includes a knowledge insight system, in accordance with some embodiments of the present disclosure.

In the embodiment of FIG. 5, a computing system 500 includes one or more user systems 510, a network 522, an application software system 530, a knowledge insight system 550, a data storage system 540, and event logging service 570.

All or at least some components of the knowledge insight system 550 are implemented at the user system 510, in some implementations. For example, one or more portions of knowledge insight system 550 can be implemented directly upon a single client device such that synthesized text is displayed to a user (or otherwise communicated) on-device without the need to communicate with, e.g., one or more servers, over the Internet. Dashed lines are used in FIG. 5 to indicate that all or portions of knowledge insight system 550 can be implemented directly on the user system 510, e.g., the user's client device. In other words, both user system 510 and knowledge insight system 550 can be implemented on the same computing device.

A user system 510 includes at least one computing device, such as a personal computing device, a server, a mobile computing device, a wearable electronic device, or a smart appliance, and at least one software application that the at least one computing device is capable of executing, such as an operating system or a front end of an online system. Many different user systems 510 can be connected to network 522 at the same time or at different times. Different user systems 510 can contain similar components as described in connection with the illustrated user system 510. For example, many different end users of computing system 500 can be interacting with many different instances of application software system 530 through their respective user systems 510, at the same time or at different times.

User system 510 includes a user interface 512. User interface 512 is installed on or accessible to user system 510 by network 522. The user interface 512 enables user interaction with the search engine 542 (in the form of entering a search request and selecting a search result from a set of search results) and/or receiving personalized supplemental content associated with the selected search result by the knowledge insight system 550.

The user interface 512 includes, for example, a graphical display screen that includes graphical user interface elements such as at least one input box or other input mechanism and a space on a graphical display into which synthesized text (or other digital content) can be loaded for display to the user. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, the graphical display may be defined using a three-dimensional coordinate system.

In some implementations, user interface 512 enables the user to upload, download, receive, send, or share of other types of digital content items, including posts, articles, comments, and shares, to initiate user interface events, and to view or otherwise perceive output such as data and/or digital content produced by application software system 530, knowledge insight system 550, and/or content distribution service 538. For example, user interface 512 can include a graphical user interface (GUI), a conversational voice/speech interface, a virtual reality, augmented reality, or mixed reality interface, and/or a haptic interface. User interface 512 includes a mechanism for logging in to application software system 530, clicking or tapping on GUI user input control elements, and interacting with digital content items. Examples of user interface 512 include web browsers, command line interfaces, and mobile app front ends. User interface 512 as used herein can include application programming interfaces (APIs).

In the example of FIG. 5, user interface 512 includes a front-end user interface component of application software system 530. For example, user interface 512 can be directly integrated with other components of any user interface of application software system 530. In some implementations, access to content of the application software system 530 and/or the knowledge insight system 550 is limited to registered users of application software system 530.

Network 522 includes an electronic communications network. Network 522 can be implemented on any medium or mechanism that provides for the exchange of digital data, signals, and/or instructions between the various components of computing system 500. Examples of network 522 include, without limitation, a Local Area Network (LAN), a Wide Area Network (WAN), an Ethernet network or the Internet, or at least one terrestrial, satellite or wireless link, or a combination of any number of different networks and/or communication links.

Application software system 530 includes any type of application software system that provides or enables the creation, upload, and/or distribution of at least one form of digital content and uploading synthesized text determined by the knowledge insight system 550. In some implementations, portions knowledge insight system 550 are components of application software system 530. Components of application software system 530 can include an entity graph 532 and/or knowledge graph 534, a user connection network 535, and a content distribution service 538, a search engine 542.

In the example of FIG. 5, application software system 530 includes an entity graph 532 and/or a knowledge graph 534. Entity graph 532 and/or knowledge graph 534 include data organized according to graph-based data structures that can be traversed via queries and/or indexes to determine relationships between entities. An example of an entity graph is shown in FIG. 6, described herein. For instance, as described in more detail with reference to FIG. 6, entity graph 532 and/or knowledge graph 534 can be used to compute various types of relationship weights, affinity scores, similarity measurements, and/or statistics between, among, or relating to entities.

Entity graph 532, 534 includes a graph-based representation of data stored in data storage system 540, described herein. For example, entity graph 532, 534 represents entities, such as users, organizations (e.g., companies, schools, institutions), content items (e.g., job postings, announcements, articles, videos, comments, and shares, as nodes of a graph), and attributes (e.g., job skills, titles). Entity graph 532, 534 represents relationships, also referred to as mappings or links, between or among entities as edges, or combinations of edges, between the nodes of the graph. In some implementations, mappings between different pieces of data used by application software system 530 are represented by one or more entity graphs. In some implementations, the edges, mappings, or links indicate online interactions or activities relating to the entities connected by the edges, mappings, or links.

Portions of entity graph 532, 534 can be automatically re-generated or updated from time to time based on changes and updates to the stored data, e.g., updates to profile data and/or activity data. Also, entity graph 532, 534 can refer to an entire system-wide entity graph or to only a portion of a system-wide graph. For instance, entity graph 532, 534 can refer to a subset of a system-wide graph, where the subset pertains to a particular user or group of users of application software system 530.

In some implementations, knowledge graph 534 is a graph-based representation of data stored in storage systems 540 that may be a subset or a superset of entity graph 532. For example, in some implementations, knowledge graph 534 includes multiple different entity graphs 532 that are joined by edges. For instance, knowledge graph 534 can join entity graphs 532 that have been created across multiple different databases or across different software products. In some implementations, knowledge graph 534 includes a platform that extracts and stores different concepts that can be used to establish links between data across multiple different software applications. Examples of concepts include topics, industries, and skills.

User connection network 535 includes, for instance, a social network service, professional social network software and/or other social graph-based applications. Content distribution service 538 includes, for example, a chatbot or chat-style system, a messaging system, such as a peer-to-peer messaging system that enables the creation and exchange of messages among users of application software system 530, or a news feed. Search engine 542 includes a search engine that enables users of application software system 530 to input and execute search queries on user connection network 535, entity graph 532, knowledge graph 534, and/or one or more indexes or data stores that store retrievable items, such as digital items that can be retrieved and included in a list of search results. In some implementations, one or more portions of knowledge insight system 550 are in bidirectional communication with search engine 542. Application software system 530 can include, for example, online systems that provide social network services, general-purpose search engines, specific-purpose search engines, messaging systems, content distribution platforms, e-commerce software, enterprise software, or any combination of any of the foregoing or other types of software.

In some implementations, a front-end portion of application software system 530 can operate in user system 510, for example as a plugin or widget in a graphical user interface of a web application, mobile software application, or as a web browser executing user interface 512. In an embodiment, a mobile app or a web browser of a user system 510 can transmit a network communication such as an HTTP request over network 522 in response to user input that is received through a user interface provided by the web application, mobile app, or web browser, such as user interface 512. A server running application software system 530 can receive the input from the web application, mobile app, or browser executing user interface 512, perform at least one operation using the input, and return output to the user interface 512 using a network communication such as an HTTP response, which the web application, mobile app, or browser receives and processes at the user system 510.

In the example of FIG. 5, application software system 530 includes a content distribution service 538. The content distribution service 538 can include a data storage service, such as a web server, which stores digital content items which can be included in a set of search results and/or retrieved to obtain supplemental information associated with a selected search result.

In some embodiments, content distribution service 538 processes requests from, for example, application software system 530 and/or knowledge insight system 550 and distributes digital content items to user systems 510 and/or the knowledge insight system 550 in response to requests. A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, or a page load. In some implementations, content distribution service 538 is part of application software system 530. In some implementations, content distribution service 538 interfaces with knowledge insight system 550, for example, via one or more application programming interfaces (APIs).

In the example of FIG. 5, application software system 530 includes a search engine 542. Search engine 542 is a software system designed to search for and retrieve information by executing queries on data stores, such as databases, connection networks, and/or graphs. The queries are designed to find information that matches specified criteria, such as keywords and phrases. For example, search engine 542 is used to retrieve data by executing queries on various data stores of data storage system 540 or by traversing entity graph 532, 534.

The knowledge insight system 550 provides synthesized and personalized supplemental information to the user. The knowledge insight system 550 interprets the user search intent using user information and the selected search result. Interpreting the user search intent allows the knowledge insight system 550 to the provide personalized and synthesized supplemental information related to the selected search result. The supplemental information is personalized because it is based on user information. The supplemental information is also synthesized because it summarizes information across multiple sources of supplemental information and provides the summarized information and the source of the information to the user. Accordingly, the knowledge insight system 550 interprets the user search intent using the user information and the selected search result and acquires and synthesizes supplemental information related to the user search intent without any additional input from the user.

The knowledge insight system 550 includes an information extractor 520. The information extractor 520 obtains an indication of the selected search result using metadata of the selected search result. For example, the information extractor 520 can receive an identification number (e.g., a job ID) that is used to map the selected search result to a content item (a particular job post). Subsequently, the information extractor 502 fetches the job details (e.g., selected search result data) based on the identification number and obtains information from the selected search result. For example, the information extractor 520 can extract all of the text included within the selected search result.

The knowledge insight system 550 includes a supplemental content identifier 524. The supplemental content identifier 524 is configured to obtain digital content items that are related to the categories and keywords associated with the selected search result (e.g., the predetermined categories and keywords and/or dynamically determined categories and keywords). The digital content items can include any digital content such as recordings, learning courses, news posts, articles, entity profiles (e.g., user profiles, organization profiles), and/or images. In some embodiments, the supplemental content identifier 524 obtains digital content items using embedding based retrieval.

The knowledge insight system 550 includes a rank manager 526. The rank manager 526 ranks digital content items in the set of digital content items with respect to a category and/or keyword. For example, the rank manager 526 ranks content of the set of digital content items based on a relevance of each content item to a category of the set of categories. Additionally or alternatively, the rank manager 526 ranks the content of the set of digital content items based on a relevance of each content item to a keyword associated with a category. The relevance of the digital content item with respect to a category and/or keyword represents the potential of the digital content item being able to fulfill the category and/or keyword.

The knowledge insight system 550 includes one or more LLMs 528. In some embodiments, the LLM 528 is configured to perform multiple tasks responsive to receiving multiple prompts. For example, given a first prompt, the LLM 528 can perform the operations of the category and keyword identifier 122 described with reference to FIG. 1. For example, the LLM 528 can identify predetermined categories and keywords (e.g., via static instructions in the first prompt, described in FIG. 2) and dynamic categories and keywords (e.g., via dynamic instructions in the first prompt, described in FIG. 2). As described herein, dynamic categories and keywords are based on user profile information (e.g., searcher data 138 described in FIG. 1) and/or the content of the selected search result.

Given a second prompt different from the first prompt, the LLM 528 can perform the operations of the summarizer 128 described with reference to FIG. 1. For example, the LLM 528 can summarize digital content items with respect to a category and/or keyword. As described herein, content items can be ranked in a group of content items based on relevance for a particular category of the set of categories or keywords of the set of keywords. In some embodiments, the top k ranked content items in the group of content items for a particular category and/or keyword are summarized. For example, the LLM 528 can synthesize information from the top k ranked content items into a summary.

Event logging service 570 captures and records network activity data generated during operation of application software system 530 and/or knowledge insight system 550, including user interface events generated at user systems 510 via user interface 512, in real time, and formulates the user interface events into a data stream that can be consumed by, for example, a stream processing system. Examples of network activity data include profile views, profile loads, search requests, clicks on messages or graphical user interface control elements, the creation, editing, sending, and viewing of messages, and social action data such as likes, shares, comments, and social reactions (e.g., “insightful,” “curious,” etc.). For instance, when a user of application software system 530 via a user system 510 clicks on a user interface element, such as a message, a link, or a user interface control element such as a view, comment, share, or reaction button, or uploads a file, or creates a message, loads a web page, or scrolls through a feed, etc., event logging service 570 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile.

For instance, when a user enters a search request and subsequently interacts with the search results, event logging service 570 stores the corresponding event data in a log. Event logging service 570 generates a data stream that includes a record of real-time event data for each user interface event that has occurred. Event data logged by event logging service 570 can be pre-processed and anonymized as needed so that it can be used, for example, to generate relationship weights, affinity scores, similarity measurements.

Data storage system 540 includes data stores and/or data services that store digital data received, used, manipulated, and produced by application software system 530 and/or knowledge insight system 550, including search requests, search results, profile information (e.g., profile data 142 as described with reference to FIG. 1), activity data (e.g., activity data 144 as described with reference to FIG. 1), digital content items, machine learning model prompts, and machine learning model parameters.

In the example of FIG. 5, data storage system 540 includes a profile data store 552, an activity data store 554, and a content item data store 556. Profile data store 552 stores profile data such as data relating to users, companies, jobs, and other entities, which are used by the knowledge insight system 550, for example, to obtain personalized supplemental content for use in the synthesized text. Activity data store 554 stores activity data such as network activity, e.g., user interface event data extracted from application software system 530 and/or event logging service 570, which are used by the knowledge insight system 550, for example, to obtain personalized supplemental content for use in the synthesized text. Content item data store 556 stores digital content items that may be uploaded by a user such as articles, and videos.

In some embodiments, data storage system 540 includes multiple different types of data storage and/or a distributed data service. As used herein, data service may refer to a physical, geographic grouping of machines, a logical grouping of machines, or a single machine.

For example, a data service may be a data center, a cluster, a group of clusters, or a machine. Data stores of data storage system 540 can be configured to store data produced by real-time and/or offline (e.g., batch) data processing. Data stored in real time is data that is stored as soon as the data is received by the data storage system 540. A data store configured for real-time data processing can be referred to as a real-time data store. A data store configured for offline or batch data processing can be referred to as an offline data store. Data stores can be implemented using databases, such as key-value stores, relational databases, and/or graph databases. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 540 resides on at least one persistent and/or volatile storage device that can reside within the same local network as at least one other device of computing system 500 and/or in a network that is remote relative to at least one other device of computing system 500. Thus, although depicted as being included in computing system 500, portions of data storage system 540 can be part of computing system 500 or accessed by computing system 500 over a network, such as network 522.

While not specifically shown, it should be understood that any of user system 510, application software system 530, knowledge insight system 550, data storage system 540, and event logging service 570 includes an interface embodied as computer programming code stored in computer memory that when executed causes a computing device to enable bidirectional communication with any other of user system 510, application software system 530, knowledge insight system 550, data storage system 540, and event logging service 570 using a communicative coupling mechanism. Examples of communicative coupling mechanisms include network interfaces, inter-process communication (IPC) interfaces and application program interfaces (APIs).

Each of user system 510, application software system 530, knowledge insight system 550, data storage system 540, and event logging service 570 is implemented using at least one computing device that is communicatively coupled to electronic communications network 522. Any of user system 510, application software system 530, knowledge insight system 550, data storage system 540, and event logging service 570 can be bidirectionally communicatively coupled by network 522. User system 510 as well as other different user systems (not shown) can be bidirectionally communicatively coupled to application software system 530 and/or knowledge insight system 550.

A typical user of user system 510 can be an administrator or end user of application software system 530. User system 510 is configured to communicate bidirectionally with any of application software system 530, knowledge insight system 550, data storage system 540, and event logging service 570 over network 522.

Terms such as component, module, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 510, application software system 530, knowledge insight system 550, data storage system 540, and event logging service 570 are implemented using computer software, hardware, or software and hardware, and can include combinations of automated functionality, data structures, and digital data, which are represented schematically in the figures. User system 510, application software system 530, knowledge system 550, data storage system 540, and event logging service 570 are shown as separate elements in FIG. 5 for ease of discussion but, except as otherwise described, the illustration is not meant to imply that separation of these elements is required. The illustrated systems, services, and data stores (or their functionality) of user system 510, application software system 530, knowledge insight system 550, data storage system 540, and event logging service 570 can be divided over any number of physical systems, including a single physical computer system, and can communicate with each other in any appropriate manner.

FIG. 6 is an example of an entity graph, in accordance with some embodiments of the present disclosure.

The entity graph 600 can be used by an application software system, e.g., a social network service, to support a user connection network, in accordance with some embodiments of the present disclosure. The entity graph 600 can be used (e.g., queried or traversed) to obtain digital content items (such as content items 160 described in FIG. 1) and/or user information (such as profile data 142 and/or activity data 144 described in FIG. 1). The digital content items may be retrieved as part of the related content 170 described in FIG. 1. Depending on the search, profile data 142 can be retrieved as part of the related content 170 described in FIG. 1. For example, a search request for a candidate with a set of skills will return a set of user candidate profiles who can perform the set of skills. Accordingly, the “content” returned in the related content 170 can be any digital content. The profile data 142 and/or activity data 144 may be retrieved as part of the searcher data 138 described in FIG. 1.

The entity graph 600 includes nodes, edges, and data (such as labels, weights, or scores) associated with nodes and/or edges. Nodes can be weighted based on, for example, similarity with other nodes, edge counts, or other types of computations, and edges can be weighted based on, for example, affinities, relationships, activities, similarities, or commonalities between the nodes connected by the edges, such as common attribute values (e.g., two users have the same job title or employer, or two users are n-degree connections in a user connection network, where n is a positive integer).

A graphing mechanism is used to create, update and maintain the entity graph. In some implementations, the graphing mechanism is a component of the database architecture used to implement the entity graph 600. For instance, the graphing mechanism can be a component of data storage system 640 and/or application software system 530, shown in FIG. 5, and the entity graphs created by the graphing mechanism can be stored in one or more data stores of data storage system 540.

The entity graph 600 is dynamic (e.g., continuously updated) in that it is updated in response to occurrences of interactions between entities in an online system (e.g., a user connection network) and/or computations of new relationships between or among nodes of the graph. These updates are accomplished by real-time data ingestion and storage technologies, or by offline data extraction, computation, and storage technologies, or a combination of real-time and offline technologies. For example, the entity graph 600 is updated in response to updates of user profiles, viewing one or more user profiles, the creation or deletion of user connections with other users, the creation and distribution of new content items, such as messages, posts, articles, comments, and shares, and the creation or deletion of user connections with content items, such as viewing a message, and saving an article. As another example, the entity graph 600 is updated as new computations are computed, for example, as new relationships between nodes are created based on statistical correlations or machine learning model output.

The entity graph 600 includes a knowledge graph that contains cross-application links. For example, profile data, activity data, and the like obtained from one or more contextual resources can be linked with entities and/or edges of the entity graph.

In the example of FIG. 6, entity graph 600 includes entity nodes, which represent entities, such as content item nodes (e.g., Post U21, Article 1, Learning Video 1), user nodes (e.g., User 1, User 2, User 3, User 4), and job nodes (e.g., Job 1, Job 2). Entity graph 600 also includes attribute nodes, which represent attributes (e.g., job title data, article title data, skill data, topic data) of entities. Examples of attribute nodes include title nodes (e.g., Title U1, Title A1), company nodes (e.g., Company 1), topic nodes (Topic 1, Topic 2), and skill nodes (e.g., Skill A1, Skill U11, Skill U31, Skill U41).

Entity graph 600 also includes edges. The edges individually and/or collectively represent various different types of relationships between or among the nodes. Data can be linked with both nodes and edges. For example, when stored in a data store, each node is assigned a unique node identifier and each edge is assigned a unique edge identifier. The edge identifier can be, for example, a combination of the node identifiers of the nodes connected by the edge and a timestamp that indicates the date and time at which the edge was created. For example, User 4 is associated with Skill U41 by virtue of the HAS edge between User 4 and U41. Similarly, User 1 is associated with Title U1 by virtue of the HAS edge between User 1 and Title U1. Similarly, User 1 is associated with Company 1 by virtue of the EMPLOYED BY edge between Company 1 and User 1.

In the entity graph 600, edges can represent activities involving the entities represented by the nodes connected by the edges. As described herein, digital content items (such as related content 170 described in FIG. 1) and/or user information (such as searcher data 138 described in FIG. 1) can be obtained using the entity graph 600 by traversing the nodes and edges of the entity graph 600. For example, given a user identifier associated with a particular user node (e.g., User 1), user information is obtained by traversing the edges of the User 1 node. For instance, profile data 142 described in FIG. 1 is part of the searcher data 138 and can be obtained by traversing the edges associated with User 1 to ascertain that User 1 has Skill U11 and Title U1.

Similarly, activity data 144 described in FIG. 1 is part of the searcher data 138 and can be obtained by traversing the edges of the entity graph 600. For example, a POSTED edge between the User 2 node and the Post U21 node indicates that the user represented by the User 2 node posted the digital content item represented by the Post U21 node to the application software system (e.g., as educational content posted to a user connection network). As another example, a SHARED edge between the User 1 node and the Post U21 node indicates that the user represented by the User 1 node shared the content item represented by the Post U21 node. Similarly, the CLICKED edge between the User 3 node and the Article 1 node indicates that the user represented by the User 3 node clicked on the article represented by the Article 1 node, and the LIKED edge between the User 3 node and the Comment U1 node indicates that the user represented by the User 3 node liked the content item represented by the Comment U1 node.

In some implementations, combinations of nodes and edges are used to compute various scores, and those scores are used as part of the user information. For example, a score that measures the affinity of the user represented by the User 1 node to Topic 2 described in the post represented by the Post U21 node can be computed using a path p1 that includes a sequence of edges between the nodes User 1 and Post U21 and/or a path p2 that includes a sequence of edges between the nodes User 1, Comment U1, and Post U21 and/or a path p3 that includes a sequence of edges between the nodes User 1, User 2, and Post U21 and/or a path p4 that includes a sequence of edges between the nodes User 1, User 3, Comment U1, Post U21. Any one or more of the paths p1, p2, p3, p4 and/or other paths through the graph 600 can be used to compute scores that represent affinities, relationships, or statistical correlations between different nodes. For instance, based on relative edge counts, a user-topic affinity score computed between User 1 and Post U21, which might be predictive of the user's interest in topic 2 of the Post U21, might be higher than the user-post affinity score computed between User 2 and Post U21 by nature of the paths of User 1 versus the paths of User 2 to arrive at node Post U21. Similarly, a user-skill affinity score computed between User 3 and Skill U31 might be higher than the user-skill affinity score computed between User 3 and Skill U11 by nature of the paths to arrive at node Skill U31 versus node Skill U11.

The examples shown in FIG. 6 and the accompanying description above are provided for illustration purposes. This disclosure is not limited to the described examples.

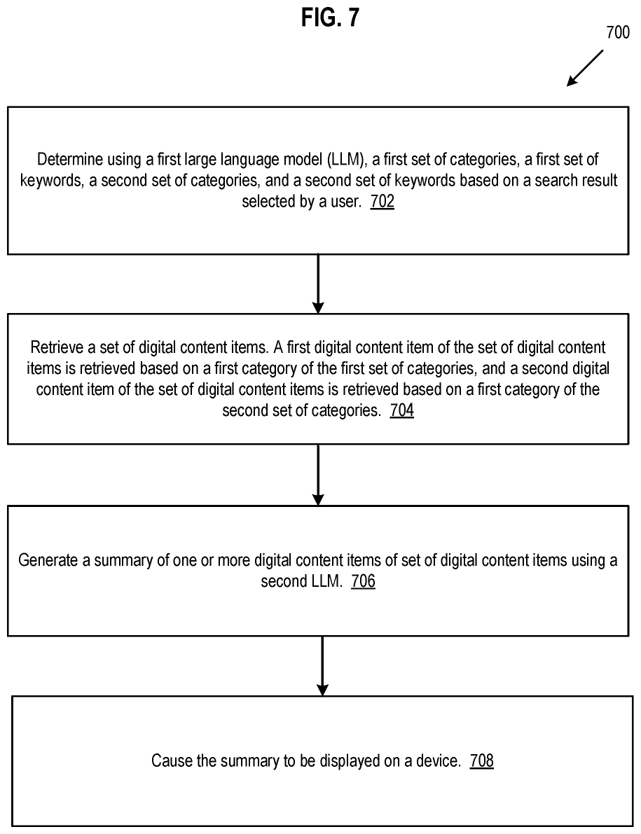

FIG. 7 is a flow diagram of an example method for providing synthesized and personalized supplemental information to the user, in accordance with some embodiments of the present disclosure.

The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 700 is performed by one or more components of the knowledge insight system 150 of FIG. 1 or the knowledge insight system 550 of FIG. 5. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 702, a processing device determines, based on a search result selected by a user, a first set of categories, a first set of keywords, a second set of categories, and a second set of keywords using a first large language model (LLM). A prompt can instruct the first LLM to determine the first set of categories, the first set of keywords, the second set of categories, and the second set of keywords. In some embodiments, the first set of categories is a predetermined set of categories, and the first set of keywords corresponds to at least one category of the first set of categories. In some embodiments, the second set of categories is based on user information associated with the user, and the second set of keywords corresponds to at least one category of the second set of categories. In some embodiments, the prompt instructs the first LLM to determine a third set of categories and a third set of keywords. The third set of categories is based on content of the search result selected by the user and the third set of keywords corresponding to a category of the third set of categories. Accordingly, the second set of categories, second set of keywords, third set of categories, and third set of keywords can be dynamically determined by the first LLM based on the search result selected by the user and the user information associated with the user that selected the search result.

At operation 704, the processing device retrieves a set of digital content items. A first digital content item of the set of digital content items is retrieved based on a first category of the first set of categories, and a second digital content item of the set of digital content items is retrieved based on a first category of the second set of categories. In some embodiments, the first digital content item of the set of digital content items is retrieved from a first database and the second digital content item of the set of digital content items is retrieved from a second database. Digital content items can be retrieved using embedding based retrieval by comparing embeddings of categories and keywords (e.g., the first set of categories, the first set of keywords, the second set of categories, the second set of keywords) to embeddings of digital content items (e.g., sentences of the digital content items, paragraphs of the digital content items). Digital content items that satisfy a threshold similarity are retrieved as digital content items of the set of digital content items.

In some embodiments, content of the search result selected by the user is obtained using metadata of the search result selected by the user. For example, metadata can include a digital content identifier. Accordingly, the content of the search result is fetched using the digital content identifier. In some embodiments, user information associated with the user is obtained using metadata associated with the user. For example, metadata can include a user profile identifier. Accordingly, user information is fetched using the user profile identifier.

At operation 706, the processing device generates a summary of one or more digital content items of set of digital content items using a second LLM. A prompt can instruct the second LLM to generate the summary of digital content items and include a reference identifier associated with a digital content item of the set of digital content items.

In some embodiments, the set of digital content items is ranked and a number of the ranked digital content items are selected (e.g., the top 3 ranked digital content items). The summary is generated using the number of ranked digital content items (e.g., the top 3 ranked digital content items).

In some embodiments, ranking the set of digital content items is based on a relevance of a digital content item of the set of digital content items to the at least one category of the first set of categories. For example, the digital content item is ranked according to the potential of the digital content item being able to fulfill a category of the first set of categories (e.g., a predetermined category). In some embodiments, ranking the set of digital content items is based on a relevance of a digital content item of the set of digital content items to the at least one keyword of the first set of keywords. For example, the digital content item is ranked according to the potential of the digital content item being able to fulfill a keyword of the first set of keywords (e.g., a keyword associated with a predetermined category). In some embodiments, ranking the set of digital content items is based on a relevance of a digital content item of the set of digital content items to the at least one category of the second set of categories. For example, the digital content item is ranked according to the potential of the digital content item being able to fulfill a category of the second set of categories (e.g., a dynamic category). In some embodiments, ranking the set of digital content items is based on a relevance of a digital content item of the set of digital content items to the at least one keyword of the second set of keywords. For example, the digital content item is ranked according to the potential of the digital content item being able to fulfill a keyword of the second set of keywords (e.g., a keyword associated with a dynamic category).

At operation 708, the processing device causes the summary to be displayed on a device y. For example, the search result selected by the user may be displayed using a webpage. Accordingly, when the summary is displayed to the user, the webpage is augmented with the summary. In some embodiments, causing the summary to be displayed on the device is in response to the selection of the search result by the user. That is the summary is provided to the user in real time.

In some embodiments, a third digital content item of the set of digital content items is retrieved based on a keyword of the first set of keywords (e.g., a keyword associated with a predetermined category). Additionally, a fourth digital content item of the set of digital content items is retrieved based on a keyword of the second set of keywords (e.g., a keyword associated with a dynamic category). In some embodiments, the summary is a first summary based on the first digital content item and the third digital content item. That is, the first summary synthesizes a digital content item related to a predetermined category (the first digital content item) and a digital content item related to a keyword associated with the predetermined category (the third digital content item). In some embodiments, the second LLM generates a second summary of the second digital content item and the fourth digital content item. That is, the second summary synthesizes a digital content item related to a dynamic category (the second digital content item) and a digital content item related to a keyword associated with the dynamic category (the fourth digital content item). Accordingly, the second LLM can generate multiple summaries given a single selected search result, based on the predetermined categories and/or keywords and/or dynamic categories and/or keywords determined from the content of the single selected search result.

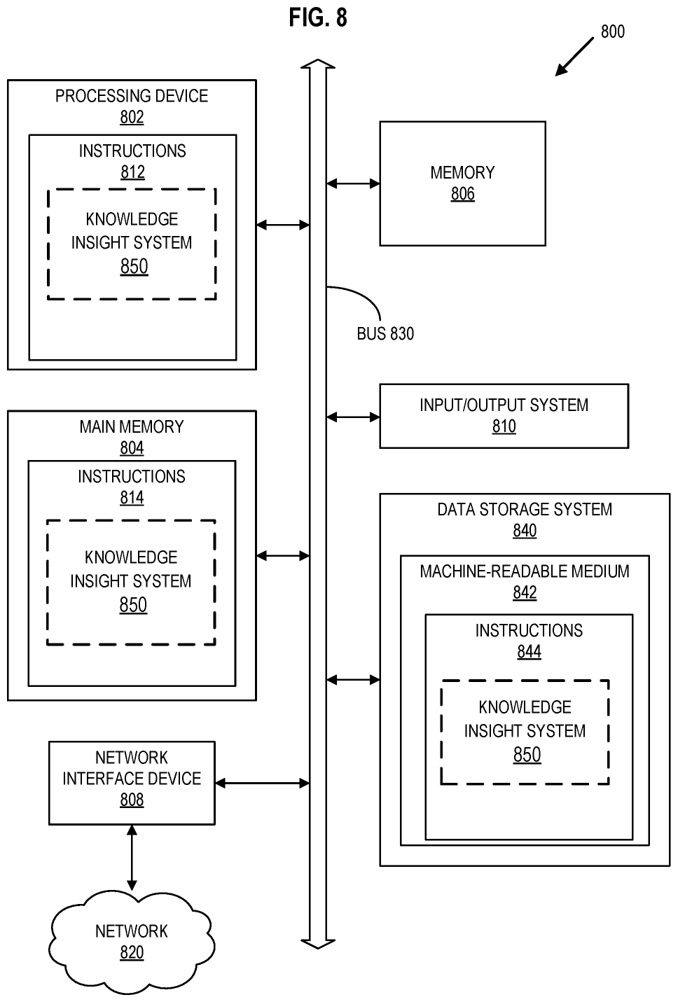

FIG. 8 is a block diagram of an example computer system including a knowledge insight system, in accordance with some embodiments of the present disclosure.

In FIG. 8, an example machine of a computer system 800 is shown, within which a set of instructions for causing the machine to perform any of the methodologies discussed herein can be executed. In some embodiments, the computer system 800 can correspond to a component of a networked computer system (e.g., as a component of the application software system 130 of FIG. 1 or the computer system 500 of FIG. 5) that includes, is coupled to, or utilizes a machine to execute an operating system to perform operations corresponding to one or more components of knowledge insight system 150 of FIG. 1, or the knowledge insight system 550 of FIG. 5. For example, computer system 800 corresponds to a portion of computing system 500 when the computing system is executing a portion of the knowledge insight system 550 of FIG. 5.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a memory 803 (e.g., flash memory, static random access memory (SRAM), etc.), an input/output system 810, and a data storage system 840, which communicate with each other via a bus 830.

Processing device 802 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be at least one special-purpose processing device such as an application specific integrated circuit (ASIC), a field programmable gate array (FPGA), a digital signal processor (DSP), network processor, or the like. The processing device 802 is configured to execute instructions 812 for performing the operations and steps discussed herein.

In some embodiments of FIG. 8, the knowledge insight system 850 represents portions of knowledge insight system 850 when the computer system 800 is executing those portions of the knowledge insight system 850. Instructions 812 include portions of knowledge insight system 850 when those portions of the knowledge insight system 850 are being executed by processing device 802. Thus, the knowledge insight system 850 is shown in dashed lines as part of instructions 812 to illustrate that, at times, portions of the knowledge insight system 850 are executed by processing device 802. For example, when at least some portion of the knowledge insight system 850 is embodied in instructions to cause processing device 802 to perform the method(s) described herein, some of those instructions can be read into processing device 802 (e.g., into an internal cache or other memory) from main memory 804 and/or data storage system 840. However, it is not required that all of the knowledge insight system 850 be included in instructions 812 at the same time and portions of the knowledge insight system 850 are stored in at least one other component of computer system 800 at other times, e.g., when at least one portion of the knowledge insight system 850 are not being executed by processing device 802.

The computer system 800 further includes a network interface device 808 to communicate over the network 820. Network interface device 808 provides a two-way data communication coupling to a network. For example, network interface device 808 can be an integrated-services digital network (ISDN) card, cable modem, satellite modem, or a modem to provide a data communication connection to a corresponding type of telephone line. As another example, network interface device 808 can be a local area network (LAN) card to provide a data communication connection to a compatible LAN. Wireless links can also be implemented. In any such implementation network interface device 808 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 800.

Computer system 800 can send messages and receive data, including program code, through the network(s) and network interface device 808. In the Internet example, a server can transmit a requested code for an application program through the Internet and network interface device 808. The received code can be executed by processing device 802 as it is received, and/or stored in data storage system 840, or other non-volatile storage for later execution.

The input/output system 810 includes an output device, such as a display, for example a liquid crystal display (LCD) or a touchscreen display, for displaying information to a computer user, or a speaker, a haptic device, or another form of output device. The input/output system 810 can include an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information can include voice commands, audio signals, geographic location information, haptic information, and/or digital imagery, for example.

The data storage system 840 includes a machine-readable storage medium 842 (also known as a computer-readable medium) on which is stored at least one set of instructions 844 or software embodying any of the methodologies or functions described herein. The instructions 844 can also reside, completely or at least partially, within the main memory 804 and/or within the processing device 802 during execution thereof by the computer system 800, the main memory 804 and the processing device 802 also constituting machine-readable storage media. In one embodiment, the instructions 844 include instructions to implement functionality corresponding to the knowledge insight system 850 (e.g., the knowledge insight system 150 of FIG. 1 or knowledge insight system 550 of FIG. 5).

Dashed lines are used in FIG. 8 to indicate that it is not required that the knowledge insight system 850 be embodied entirely in instructions 812, 814, and 844 at the same time. In one example, portions of the knowledge insight system 850 are embodied in instructions 814, which are read into main memory 804 as instructions 814, and portions of instructions 812 are read into processing device 802 as instructions 812 for execution. In another example, some portions of the knowledge insight system 850 are embodied in instructions 844 while other portions are embodied in instructions 814 and still other portions are embodied in instructions 812.

While the machine-readable storage medium 842 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 8 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 500, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
determining, based on a search result selected by a user, using a first large language model (LLM), a first set of categories, a first set of keywords, a second set of categories, and a second set of keywords, wherein:
the first set of categories is a predetermined set of categories, and the first set of keywords corresponds to at least one category of the first set of categories;
the second set of categories is based on user information associated with the user, and the second set of keywords corresponds to at least one category of the second set of categories;
retrieving a set of digital content items, wherein a first digital content item of the set of digital content items is retrieved based on a first category of the first set of categories, and wherein a second digital content item of the set of digital content items is retrieved based on a first category of the second set of categories;
generating, using a second LLM, a summary of one or more digital content items of the set of digital content items; and
causing the summary to be displayed on a device.

2. The method of claim 1, wherein a third digital content item of the set of digital content items is retrieved based on a keyword of the first set of keywords and wherein a fourth digital content item of the set of digital content items is retrieved based on a keyword of the second set of keywords, wherein the summary is a first summary of the first digital content item and the third digital content item, further comprising:
generating, using the second LLM, a second summary of the second digital content item and the fourth digital content item.

3. The method of claim 1, wherein the search result is displayed on the device using a webpage, and wherein causing the summary to be displayed further comprises augmenting the webpage with the summary.

4. The method of claim 1, wherein causing the summary to be displayed on the device is in response to the selection of the search result by the user.

5. The method of claim 1, further comprising:
ranking the set of digital content items based on:
a relevance of a digital content item of the set of digital content items to the at least one category of the first set of categories,
a relevance of the digital content item of the set of digital content items to at least one keyword of the first set of keywords,
a relevance of the digital content item of the set of digital content items to the at least one category of the second set of categories, or
a relevance of the digital content item of the set of digital content items to at least one keyword from the second set of keywords.

6. The method of claim 5, wherein generating, using the second LLM, the summary of the set of digital content items further comprises:
selecting a number of ranked digital content items; and
generating, using the second LLM, a summary of the number of ranked digital content items.

7. The method of claim 1, wherein the first LLM receives a first prompt and the second LLM receives a second prompt, wherein the first prompt is different from the second prompt.

8. The method of claim 1, wherein the summary comprises a reference identifier associated with a digital content item of the set of digital content items.

9. The method of claim 1, wherein the first digital content item of the set of digital content items is retrieved from a first database and the second digital content item of the set of digital content items is retrieved from a second database.

10. The method of claim 1, further comprising:
determining, based on the search result selected by the user, using the first LLM, a third set of categories and a third set of keywords, wherein the third set of categories is based on content of the search result selected by the user, and the third set of keywords corresponds to at least one category of the third set of categories.

11. The method of claim 1, further comprising:
obtaining content of the search result selected by the user using metadata of the search result selected by the user; and
obtaining the user information associated with the user using metadata associated with the user.

12. The method of claim 11, wherein determining, using the first LLM, the first set of categories, the first set of keywords, the second set of categories, and the second set of keywords, is further based on the content of the search result selected by the user and the user information associated with the user.

13. A system comprising:
at least one processor; and
at least one memory device coupled to the at least one processor, wherein the at least one memory device comprises instructions that, when executed by the at least one processor, cause the at least one processor to perform at least one operation comprising:
determining, based on a search result selected by a user, using a first large language model (LLM), a first set of categories, a first set of keywords, a second set of categories, and a second set of keywords, wherein:
the first set of categories is a predetermined set of categories, and the first set of keywords corresponds to at least one category of the first set of categories;
the second set of categories is based on user information associated with the user, and the second set of keywords corresponds to at least one category of the second set of categories;
retrieving a set of digital content items, wherein a first digital content item of the set of digital content items is retrieved based on a first category of the first set of categories, and wherein a second digital content item of the set of digital content items is retrieved based on a first category of the second set of categories;
generating, using a second LLM, a summary of one or more digital content items of the set of digital content items; and
causing the summary to be displayed on a device.

14. The system of claim 13, wherein a third digital content item of the set of digital content items is retrieved based on a keyword of the first set of keywords and wherein a fourth digital content item of the set of digital content items is retrieved based on a keyword of the second set of keywords, wherein the summary is a first summary of the first digital content item and the third digital content item, and wherein the instructions, when executed by the at least one processor, cause the at least one processor to perform at least one operation further comprising:
generating, using the second LLM, a second summary of the second digital content item and the fourth digital content item.

15. The system of claim 13, wherein the search result is displayed on the device using a webpage, and wherein causing the summary to be displayed further comprises augmenting the webpage with the summary.

16. The system of claim 13, wherein causing the summary to be displayed on the device is in response to the selection of the search result by the user.

17. A non-transitory computer-readable storage medium comprising instructions that, when executed by at least one processor, cause the at least one processor to perform at least one operation comprising:
determining, based on a search result selected by a user, using a first large language model (LLM), a first set of categories, a first set of keywords, a second set of categories, and a second set of keywords, wherein:
the first set of categories is a predetermined set of categories, and the first set of keywords corresponds to at least one category of the first set of categories;
the second set of categories is based on user information associated with the user, and the second set of keywords corresponds to at least one category of the second set of categories;
retrieving a set of digital content items, wherein a first digital content item of the set of digital content items is retrieved based on a first category of the first set of categories, and wherein a second digital content item of the set of digital content items is retrieved based on a first category of the second set of categories;
generating, using a second LLM, a summary of one or more digital content items of the set of digital content items; and
causing the summary to be displayed on a device.

18. The non-transitory computer-readable storage medium of claim 17, wherein a third digital content item of the set of digital content items is retrieved based on a keyword of the first set of keywords and wherein a fourth digital content item of the set of digital content items is retrieved based on a keyword of the second set of keywords, wherein the summary is a first summary of the first digital content item and the third digital content item, and wherein the instructions, when executed by the at least one processor, cause the at least one processor to perform at least one operation further comprising:
generating, using the second LLM, a second summary of the second digital content item and the fourth digital content item.

19. The non-transitory computer-readable storage medium of claim 17, wherein the search result is displayed on the device using a webpage, and wherein causing the summary to be displayed further comprises augmenting the webpage with the summary.

20. The non-transitory computer-readable storage medium of claim 17, wherein causing the summary to be displayed on the device is in response to the selection of the search result by the user.
